(19) United States
(12) Patent Application Publication
(10) Pub. No.: US 2011/0120329 A1
(43) Pub. Date: May 26, 2011

(54) METHOD AND APPARATUS FOR ROLL-TO-ROLL TYPE PRINTING

(76) Inventors: Kee-Hyun Shin, Seongnam-si (KR); Yun Shick Eom, Seoul (KR); Jang Won Lee, Seoul (KR); Ho Joon Kim, Dalseo-gu (KR)

(21) Appl. No.: 12/950,960

(22) Filed: Nov. 19, 2010

Related U.S. Application Data
(63) Continuation of application No. PCT/KR2008/003681, filed on Jun. 26, 2008.

(30) Foreign Application Priority Data
May 21, 2008 (KR) 10-2008-0047272

(51) Int. Cl. B41F 11/00; B41F 33/00

(52) U.S. Cl. 101/214; 101/483

(57) ABSTRACT

A method and apparatus for high-speed roll-to-roll printing, ensuring high-precision printing previously available only under a static condition. In the present invention, a pattern mask is wound on a print roll, and an ink injector and the roll are configured to maintain a substantially zero linear speed difference between the pattern mask and a print substrate at the moment the ink injector injects ink onto the print substrate through a perforated pattern in the pattern mask. The ink injector may be mounted on the print roll, may rotate separately from the rotating roll with a different rotational speed and direction, and may axially move to ensure no relative movement existing between the pattern mask and the substrate at the moment of printing. The roll may move linearly in the same direction as the substrate. A position sensor may be employed for more precise alignment between substrates in a multilayer printing.

### CROSS-REFERENCE TO RELATED APPLICATIONS

This application claims priority to and is a continuation of a co-pending International Application No. PCT/KR2008/003681 filed on Jun. 26, 2008, which claimed priority to a patent application No. KR 10-2008-0047272, filed on May 21, 2008, in Korea, and hereby claims the benefit thereof.

### BACKGROUND OF THE INVENTION

The present invention relates to a roll-to-roll printing method and apparatus, and more particularly, to a roll-to-roll printing method and apparatus for printing electronic devices including, but not limited to, electronic circuits, solar cells, electronic books, flexible displays, using organic ink or inorganic ink.

Generally, roll-to-roll printing is a next-generation technology that was recently introduced and has spread into production lines for important electronic components such as printed circuit boards (PCBs). The application of roll-to-roll printing to manufacturing of electrical devices has contributed to a remarkable reduction in production cost and time.

Conventional manufacturers of electrical devices such as PCBs have adopted a sheet type process, in which a printed substrate such as a FCCL (Flexible Copper Clad Laminate) is cut to a desired length and is then processed. In a recently developed roll-to-roll technology, a FCCL is directly wound around a rotating roll without having to perform the cutting procedure performed in the conventional art.

The roll-to-roll technology is advantageous over the conventional sheet type process because the former greatly reduces labor power, and production cost and time.

A direct application of a conventional printing technology such as inkjet printing, gravure printing or offset printing to the roll-to-roll printing, however, encounters many technical problems. One of the problems is the difficulty in controlling registration, i.e., controlling a precise positioning in printing, at the moment of transferring ink, due to the speed difference between a gravure pattern and a print substrate, or between an ink injection device and a print substrate.

Other difficulties for applying the conventional printing technology to the roll-to-roll printing arise, for example, in making patterns, in restricting an amount of ink transferred to the substrate, and in dealing with precipitation of ink into a pattern or unevenness of printed circuits.

In addition, the application of a conventional pattern mask technology, such as gravure printing, to a roll-to-roll process requires a doctoring procedure, which is conducted to uniformly scrape off ink on a roll. One drawback of the doctoring procedure is that the heat generated during the procedure may cause an undesirable change in the ink viscosity.

Another problem for applying a conventional pattern mask technology to a roll-to-roll process is that when ink is transferred to a surface of a target substrate, a sufficient amount of ink is not transferred because of the remnant ink remaining in cells of a gravure or offset plate, thus causing a loss of ink and deterioration of an ink transfer efficiency.

Therefore, there is a need in the art to provide an apparatus and method for roll-to-roll printing that ensures an ultra-high printing precision such as obtainable in a static printing condition, in which ink is transferred while a speed difference between a pattern and a target substrate is maintained substantially at zero.

Also, there is a need in the art to provide an apparatus and method for roll-to-roll printing that, even when a conventional pattern mask technology is employed, does not require a doctoring procedure that causes undesirable the ink viscosity change.

Further, there is a need in the art to provide an apparatus and method for roll-to-roll printing that solves the problem of insufficient transfer of ink to a target substrate in conventional printings such as a gravure or offset printing, and thus greatly improves ink transfer efficiency.

### SUMMARY OF THE INVENTION

In accordance with the needs and problems recognized in the prior art for the application of a conventional pattern mask technology to a roll-to-roll process, an object of the present invention is to provide a roll-to-roll printing method and apparatus that ensures an ultra-high printing precision that otherwise could be obtainable only in a static printing condition, in which ink is transferred while a speed difference between a pattern and a target substrate is maintained to be substantially at zero.

Another object of the present invention is to provide a roll-to-roll printing method and apparatus that eliminates the need for a doctoring procedure, and thereby eliminating the undesirable change in ink viscosity.

Still another object of the present invention is to provide a roll-to-roll printing method and apparatus that ensures a sufficient transfer of ink to a target substrate so as to improve ink transfer efficiency.

In light of the afore-stated objects of the invention, the present invention provides, in an aspect of the invention, a roll-to-roll printing method including: moving a print substrate in a direction; disposing a pattern mask over the print substrate, wherein the pattern mask has a perforated pattern thereon to be printed on the print substrate, wherein the pattern mask is wound on a roll such that a side of the pattern mask faces the print substrate; injecting ink onto the print substrate through the perforated pattern; and maintaining a speed difference between the pattern mask and the print substrate substantially at zero the moment the ink is injected.

The roll-to-roll printing method may further include rotating an ink injector and rotating the roll that may rotate in mutually different directions, and controlling their respective rotation speeds. The ink injector may be mounted on the roll along an axis of the roll that is perpendicular to the moving direction of the printing substrate. Also, the ink injector may be configured to be capable of moving in the axial direction of the roll and the roll may be configured to move in the same direction as the moving direction of the printing substrate to ensure a relative speed between the pattern mask and the print substrate to be substantially zero.

The roll-to-roll printing method may further include detecting a position of a pattern previously printed on the print substrate using a position sensor, and controlling a relative position between the print substrate and the pattern mask utilizing the detected position. The control of the relative position between the print substrate and the pattern mask may be performed by controlling the relative rotations of the ink injector and the roll, depending on the detected position.

In another aspect of the invention, the roll-to-roll printing method may include: moving a print substrate in one direction; moving a pattern mask in the same direction as the moving direction of the printing substrate, wherein the pattern mask has a perforated pattern thereon to be printed on the print substrate, and is wound in a loop fashion around at least two rolls spaced apart from each other at a predetermined interval such that a side of the pattern mask faces the print substrate; and injecting ink from an ink injector onto the print substrate through the perforated pattern on the pattern mask; and maintaining a speed difference between the pattern mask and the print substrate substantially at zero at the moment the ink is injected.

The roll-to-roll printing method may further include detecting a position of a pattern previously printed on the print substrate; and aligning the print substrate and the pattern mask using the detected position. The alignment of the print substrate and the pattern mask may be achieved by moving a drive structure that transfers the pattern mask in a direction parallel or perpendicular to the moving direction of the printing substrate, or by rotating the drive structure, depending on the detected position.

In order to accomplish afore-stated objects of the invention, the present invention also provides an apparatus implementing the roll-to-roll printing method provided in the present invention. In an aspect of the invention, the apparatus may include: a print substrate moving in one direction; a roll disposed over the print substrate; a pattern mask wound on the roll such that a side of the pattern mask faces the print substrate, wherein the pattern mask has a perforated pattern to be printed on the print substrate; and an ink injector disposed over the print substrate and configured to inject ink onto the print substrate through the perforated pattern of the pattern mask, wherein the roll and the ink injector are configured such that a speed difference between the pattern mask and the print substrate is maintained substantially at zero at the moment the ink injector injects ink.

The apparatus may further include a first drive unit for rotating the ink injector; a second drive unit for rotating the roll; at least one position sensor for detecting a position of a pattern previously printed on the print substrate; and a control unit for controlling the first and second drive units to adjust a relative position between the print substrate and the pattern mask, depending on the detected position by the at least one position sensor. The first and second drive units may be configured to rotate the ink injector and the roll in different directions.

In an aspect, the ink injector may be mounted on the roll, preferably, along an axis of the roll, which is perpendicular to the moving direction of the printing substrate. Also, the ink injector may be configured to be capable of moving in the axial direction of the roll and the roll may be configured to move in the same direction as the moving direction of the printing substrate to ensure a relative speed between the pattern mask and the print substrate to be substantially zero.

In another aspect of the invention, the apparatus for a roll-to-roll printing method may include: a print substrate moving in one direction; at least two spaced-apart rotating rolls; a pattern mask wound around the rolls in a loop fashion such that a side of the pattern mask faces the print substrate, wherein the pattern mask has a perforated pattern to be printed on the print substrate; and an ink injector disposed over the print substrate and configured to inject ink onto the print substrate through the perforated pattern of the pattern mask, wherein the at least two rolls and the ink injector are configured such that a speed difference between the pattern mask and the print substrate is maintained substantially at zero at the moment the ink injector injects ink.

The apparatus may further include: at least one position sensor for detecting a position of a pattern previously printed on the print substrate; and a drive structure in mechanical communication with the at least two rolls for transferring the pattern mask, wherein the drive structure is configured to move in a direction parallel or perpendicular to the moving direction of the printing substrate or rotate, depending on the detected position, for aligning the print substrate and the pattern mask.

In the roll-to-roll printing method and apparatus according to the present invention, a pattern mask is formed on a surface of a roll, and an ink injector injects ink through the pattern while the roil is in contact with a print substrate without a relative movement therebetween. Consequently, the present invention provides an advantage of ensuring such a printing precision as can be obtained only when printing is performed under a static condition, and makes it possible to implement a high-speed, high-precision printing by using a roll-to-roll type technology, thereby greatly enhancing productivity and reducing cost and time for production.

Another advantage provided by the present invention is that even when a pattern mask technology is applied to the roll-to-roll process, the present invention obviates the need for a doctoring procedure, which is conducted to uniformly scrape off ink on a surface of a roll in, for example, gravure printing, and avoids the undesirable change of ink viscosity caused by heat generated during the doctoring procedure.

Still another advantage provided by the present invention is the prevention of ink loss due to the remnant ink in the cells of a gravure or offset plate, which causes insufficient transfer of the ink to a surface of a target substrate. Thus, the present invention greatly improves ink transfer efficiency as well.

### BRIEF DESCRIPTION OF THE DRAWINGS

FIG. 1 is a schematic view of a roll on which a pattern mask is formed, according to the present invention;

FIG. 2 is a schematic view of an embodiment in the present invention of an ink injector, a roll, and a print substrate;

FIG. 3 is a schematic view of a roll-to-roll printing process in an embodiment of the present invention, in which a pattern is printed on a substrate using a pattern mask at a contact point where a relative speed between the pattern mask and the substrate is zero;

FIG. 4 is a schematic view of a roll-to-roll printing process in another embodiment of the present invention;

FIG. 5 is a schematic view of another arrangement for the embodiment shown in FIG. 4, which is configured for the registration between print substrates;

FIG. 6 is a schematic view of a roll in an embodiment of the present invention, which includes one or more ink injectors joined thereto;

FIG. 7 is a schematic view of ink injectors in an embodiment of the present invention, which are configured to rotate using an internal rotating shaft;

FIG. 8 is a schematic view of a roll-to-roll printing apparatus in an embodiment of the present invention;

FIG. 9 is a schematic view of the mechanical configuration of a roller and ink injectors mounted thereon in an embodiment of the present invention;

FIG. 10 is a schematic view of a roll, in one embodiment of the present invention, where the roll moves in the same direction and with the same speed as a print substrate.

FIG. 11 is a schematic view of an arrangement of printing rolls according to the present invention, in which a wrap angle is increased to ensure a sufficient printing time; and

FIG. 12 is a schematic view of another arrangement of printing rolls according to the present invention.

### DETAILED DESCRIPTION OF THE PREFERRED EMBODIMENT

The drawings to be described herein are shown for purposes of illustrating only certain embodiments of the present invention, and not for any purpose of limiting the invention. Further, the terms and words used in the present specification and claims should not be interpreted as being limited to typical meanings or dictionary definitions, but should be interpreted as having meanings and concepts relevant to the technical scope of the present invention.

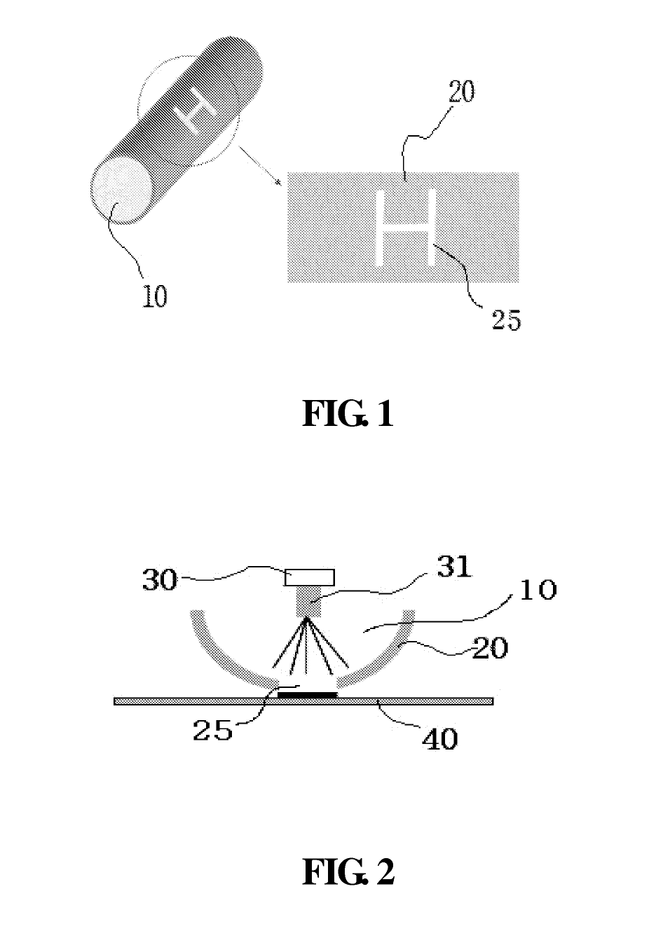

Referring now to FIGS. 1-12, FIG. 1 is a schematic view of a printing roll and a pattern mask according to the present invention. The pattern mask 20 has a pattern 25, the letter ‘H,’ perforated thereon so that ink may be injected through the perforated pattern 25 on a substrate during printing. In the present invention, the pattern mask 20 is wound around the printing roll 10 to ensure precise registration as further described hereinafter. Furthermore, in the present invention the process of forming a pattern on a roll can be facilitated and simplified, and thus reducing costs required for the formation of the pattern. Especially when the pattern-mask type printing technology is applied to the roll-to-roll printing process as illustrated in FIG. 1, even a printing pattern having a large area can be printed with high speed and precision if the pattern mask is wound on a printing roll.

FIG. 2 is a schematic view of an embodiment in the present invention of an ink injector, a roll, and a print substrate. In this embodiment, an ink injector 30 having an injection nozzle 31 is disposed within the roll 10 on which a pattern mask 20 is wound. When the roll 10 is aligned such that the perforated pattern 25 is precisely positioned upon a point on a print substrate 40 on which the pattern is to be printed, the ink injector 30 is activated to inject ink from the injection nozzle 31 through the perforated pattern 25 onto the print substrate 40 to print the pattern thereon. The ink injector 30 generally includes a typical inkjet head and may also include other various kinds of ink injectors known in the art.

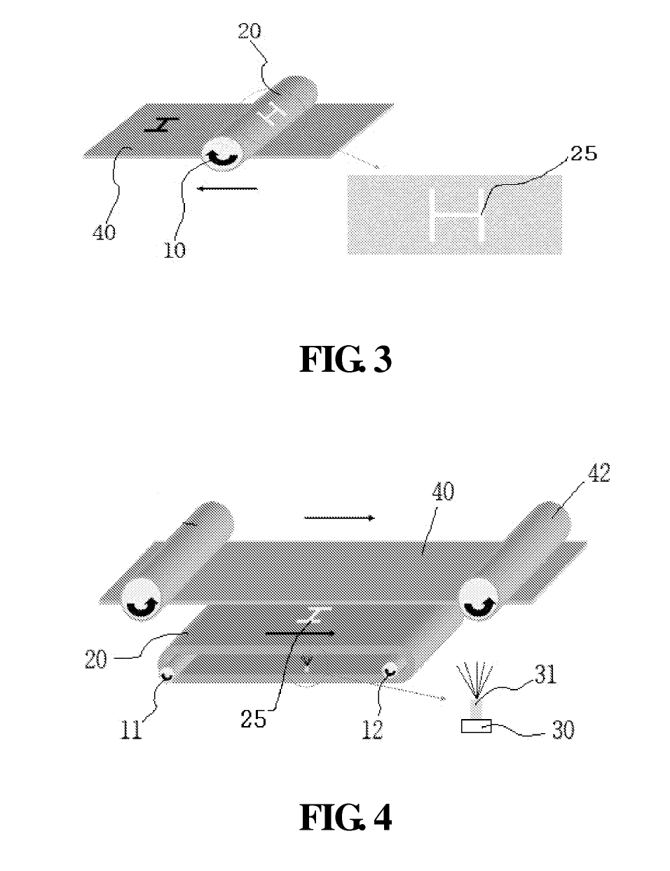

FIG. 3 is a schematic view of a roll-to-roll printing process in an embodiment of the present invention, in which a pattern is printed on a substrate using a pattern mask at a contact point while a relative speed, or the speed difference, between the pattern mask and the substrate is maintained to be substantially or exactly zero at the moment the ink is injected and sprayed onto the print substrate 40. As shown in FIG. 3, in the present invention, while the print substrate 40 moves linearly in one direction with a certain speed, the roll 10 in which an ink injector is mounted as shown in FIG. 2 also rotates. In the preferred embodiment, the roll 10 and the ink injector 30 mounted within the roll 10 are rotated by separate drive units as will be described hereinafter, so that they may be capable of rotating in different directions with different rotational or angular speeds, if needed. The individual rotational speeds and directions of rotation of the roll 10 and the ink injector 30 therein are controlled such that at the moment of printing the perforated pattern 25 upon the print substrate 40 by injecting ink through the perforated pattern 25, the speed difference between the pattern mask 20 and the substrate 40, that is, the difference of the instantaneous linear speed of the pattern mask 20, calculable from its rotational angular speed, from the linear speed of the substrate 40, becomes substantially zero.

By eliminating the speed difference between the printing apparatus and the target print substrate, the present invention ensures a precise alignment between the printing apparatus and the target print substrate to achieve high-precision printing as well as high-speed production. Further, the present invention also ensures precise alignment between print substrates, that is, the alignment between a substrate printed previously and a substrate to be currently printed, in multilayer printing. Typically, the alignment between print substrates in the case of a conventional printing process such as gravure or offset type printing is performed by a phase control of a roll, which is known to have many incidental adverse effects including, for example, variation in strain or tension on the substrate arising from the phase change of the roll that is in contact with the substrate during printing. By contrast, in the present invention, in which a pattern mask is wound around a roll as shown in FIGS. 1-3 and the ink injector and the roll are configured to be separately moved, more precise alignment between print substrates is enabled to reduce such adverse effect involved in the conventional printing process and achieve more precise printing.

FIG. 4 is a schematic view of a roll-to-roll printing process in another embodiment of the present invention. In this embodiment, a print substrate 40 is transferred in one direction using one or more rotating shaft 42, and a pattern mask 20 having a perforated pattern 25 (letter ‘I’) is moving parallel to and in the same moving direction of the print substrate 40, while being in contact with a print substrate 40. Preferably, the pattern mask 20 may be moving in a looping fashion around two or more rotating rolls 11, 12. One or more ink injector 30 with an injection nozzle 31 is positioned below the pattern mask 20 and injects ink through the perforated pattern 25 to print a pattern on the print substrate 40. To ensure precise printing, the pattern mask 20 is configured to move with the same speed as the print substrate 40, while in contact thereto, such that the speed difference between the pattern mask and the print substrate is maintained substantially at zero at the moment the ink injector 30 injects ink.

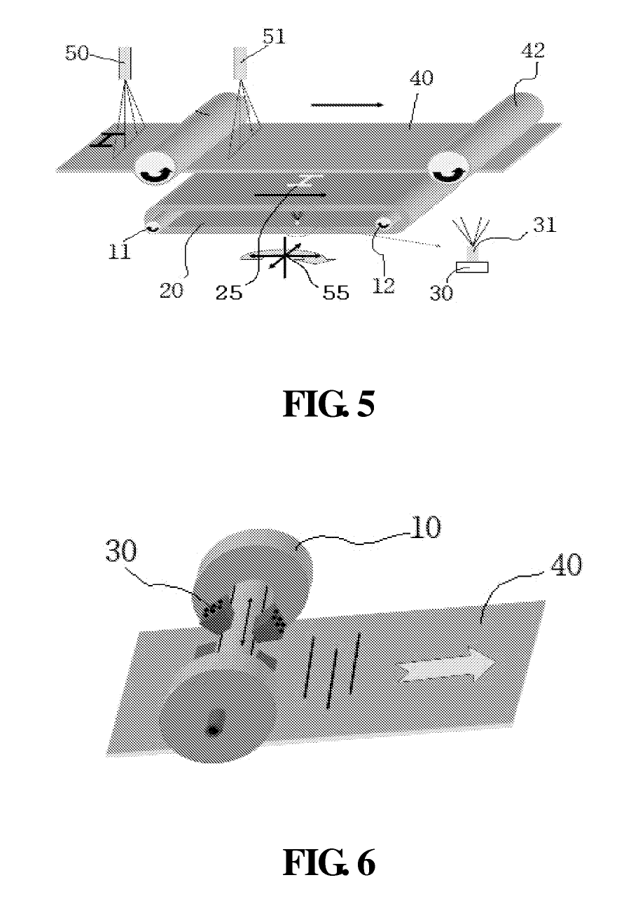

FIG. 5 is a schematic view of how registration between print substrates can be controlled in the embodiment of the present invention depicted in FIG. 4. As shown in FIG. 5, a position of a previously printed pattern on a print substrate 40 is detected by using one or more position sensors 50, 51. A drive structure 55, which is connected to the pattern mask 20 to move it when needed for registration control, is configured to be capable of moving the pattern mask 20 either parallel or perpendicular to the moving direction of the printing substrate 40 as indicated by the two perpendicular arrows 2A and 2B in FIG. 5, or in some embodiment, slightly rotating or tilting the pattern mask 20 from a horizontal plane defined by the arrows 2A and 2B. Further, the drive structure 55 is, preferably, capable of moving the pattern mask 20 in a direction perpendicular to the face of the printing substrate 40, as shown by the vertical line 2C crossing the arrows 2A and 2B in FIG. 5, so as to detach the pattern mask 20 from the printing substrate 40 the printing substrate 40 while the position of the perforated pattern 25 is adjusted by moving the pattern mask 20. Depending on the position of a previously printed pattern on the substrate 40 detected by the one or more sensors 50, 51, the drive structure 55, first, detaches the pattern mask 20 from the printing substrate 40 and adjusts the position and orientation of the perforated pattern 25 by moving the pattern mask 20 either parallel or perpendicular to the moving direction of the printing substrate 40 to a degree necessary for achieving precise alignment between the print substrate 40 and the pattern mask 20 in view of the detected previously printed pattern. Then, the pattern mask 20 moves back using the drive structure 55 toward the printing substrate 40 so that a precise printing is executed therebetween while they are in contact.

Although the pattern mask 20 is to move, preferably in this embodiment, with the same speed as the print substrate 40 such that the speed difference between the pattern mask 20 and the print substrate in this embodiment 40 is maintained substantially at zero at the moment the ink injector 30 injects ink, the speed of the pattern mask 20 also may be slightly changed, if necessary for a more precise alignment, using the drive structure 55 or other drivers.

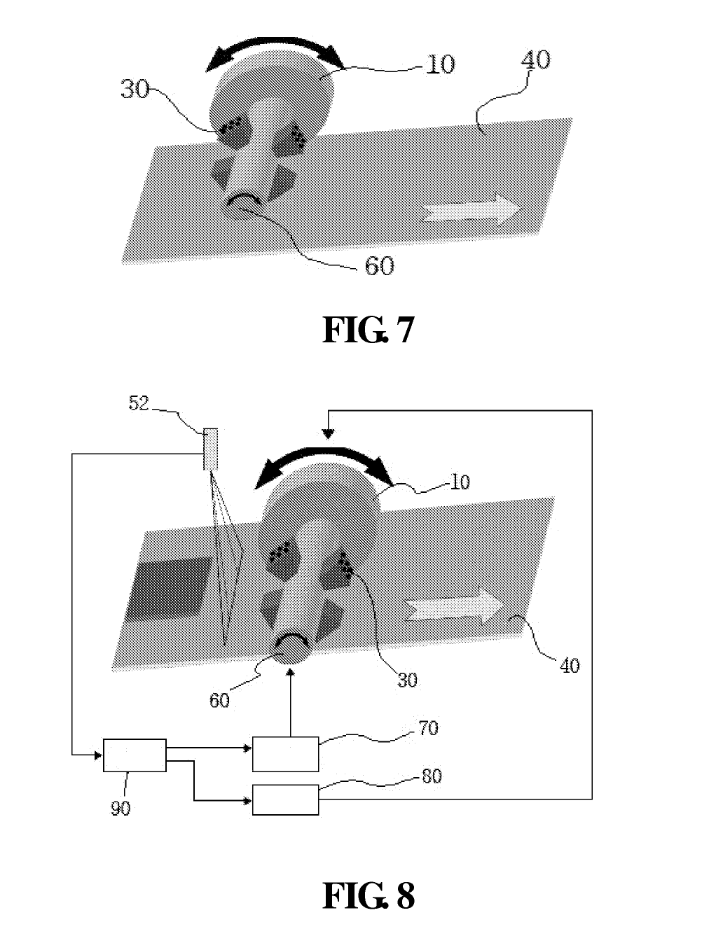

FIGS. 6 and 7 are schematic views of a roll and ink injectors in an embodiment of the present invention. In this embodiment, one or more ink injectors 30 are mounted on the roll 10. Preferably, the ink injectors 30 are mounted along the axis of the rotating roll 10, as shown in FIGS. 6 and 7. Further, as shown in FIG. 7, the ink injectors 30 may be configured to rotate, using an internal rotating shaft 60, separately and independently from the rotating roll 10, with a different speed and/or different direction of rotation. Also, as shown in FIG. 6, the ink injectors 30 may be configured to axially move along the internal rotating shaft 60, if needed for more precisely aligning the pattern mask with the print substrate at the moment the ink is injected from the ink injectors 30, so that a more precise printing can be achieved.

The capability of adjusting the positions of the pattern mask and the ink injector upon a print substrate by separately rotating the printing roll and the ink injector and axially moving the ink injector as desired in the present invention allows an extremely fine alignment between a printing apparatus and a print substrate at the moment of printing by injecting ink, and accomplishes printing on a moving substrate with ultra-high precision in a roll-to-roll process and enhancement if productivity. Further, such capability enables execution of further printing on a substrate having a previously printed pattern without having to contact the previously printed pattern, which is likely to cause blurring, smearing, or other errors.

FIG. 8 is a schematic view of a roll-to-roll printing apparatus in one embodiment of the present invention, in which a plurality of ink injectors 30 capable of rotation and axial movement using an internal rotating shaft 60 are mounted on a rotating roll 10 as also illustrated in FIGS. 6 and 7. More specifically in this embodiment, the rotation and axial movement of the ink injectors 30 are controlled by a first drive unit 70, which controls the movement of the internal rotating shaft 60. The rotation of the roll 10, or the rotation of the pattern mask wound around the roll 10, is controlled by a second drive unit 80. The first and second drive units, 70 and 80, are in turn controlled by a control unit 90.

FIG. 8 schematically illustrates a method of detecting a register error for more precise printing. Specifically, before the substrate 40 reaches the rotating roll 10, a position sensor 52 detects a pre-printed pattern on the substrate 40. Then, an electronic signal for the detected position is transferred to the control unit 90, which, upon receiving the signal, generates another electronic signals to control the first and second drive units, 70 and 80, so as to control the relative motion of the roll 10 and the ink injectors 30, and thereby to adjust a relative position between the print substrate 40 and the pattern mask. The ink injectors 30 and the printing roll 10 may be separately rotated according to the commands from the first and second drive units, 70 and 80, to ensure that the injection of the ink may be executed at the precise location on a print substrate 40 when the substrate 40 arrives under the roll 10. The method in the present invention not only enhances printing precision, but also remarkably reduces the amount of ink used for printing by permitting ink to be applied to the precise location.

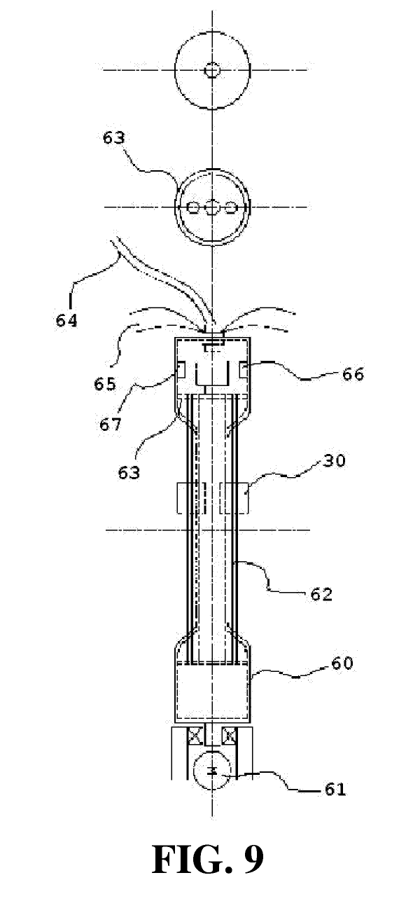

FIG. 9 is a schematic view of the mechanical configuration of a roller and ink injectors mounted on the roll in an embodiment of the present invention. In this embodiment, an internal rotating shaft 60 is rotated by a shaft motor 61. The ink injectors 30 are supported by a transfer shaft 62 that is positioned in parallel to the internal rotating shaft 60 and capable of axially moving along the transfer shaft 62, as illustrated in FIG. 6, using a head-transfer motor 66. The transfer shaft 62 is connected to the other side using a plurality of bearings. Ink is supplied to the ink injectors 30 using an ink supply nozzle 64, and power is supplied through power lines 65. A control motor 67 controls the overall registration.

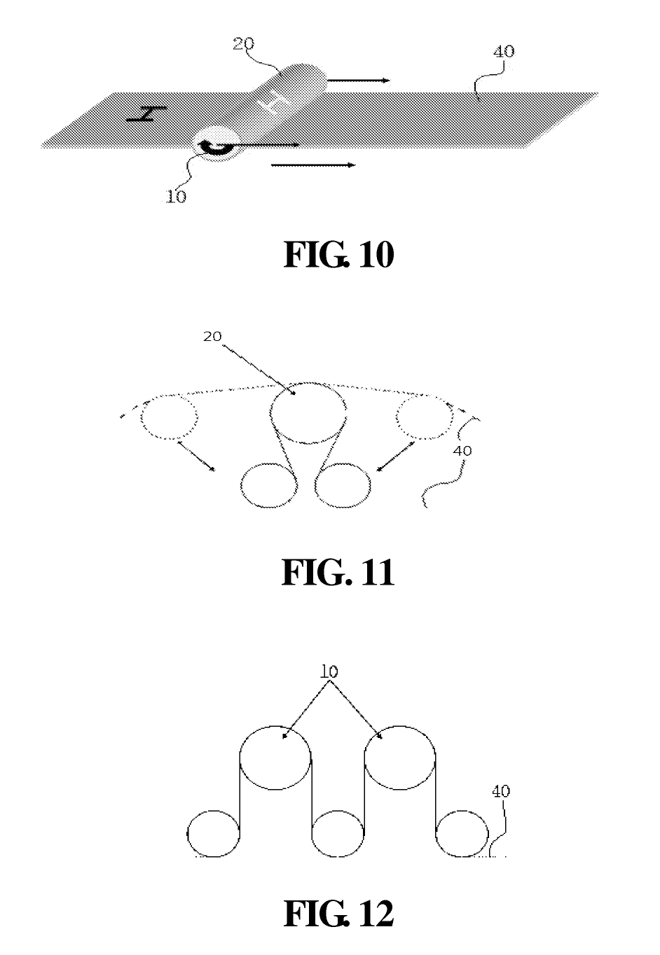

FIG. 10 is a schematic view of a roll, in one embodiment of the present invention, where the roll moves in the same direction and with the same speed as a print substrate. In the roll-to-roll printing process, the printing is accomplished by injection of ink upon the substrate for only a short duration while the substrate is in contact with, or passes under, a roll and a pattern mask. But there may be occasions, depending on the specific type of printing, substrate or ink, when such a duration is not long enough to accomplish a printing of a desired quality. In those occasions, there may be a need to extend a printing time while still maintaining the speed difference between the pattern mask 20 and the print substrate substantially at zero. To meet such a need, in another embodiment of the present invention, the pattern mask 20, or the roll 10 having the pattern mask 20, may be further configured to linearly move in the same direction and with the same speed as those of the print substrate material 40. In this fashion, the printing time can be extended while the speed difference between the pattern mask 20 and the print substrate 40 is maintained substantially at zero.

FIG. 11 is a schematic view of an arrangement of printing rolls 10 according to the present invention, in which a wrap angle is increased to ensure a sufficient printing time, and FIG. 12 is a schematic view of another arrangement of printing rolls 10 according to the present invention. As shown in FIGS. 11 and 12, by using a plurality of printing rolls, a variety of patterns can be printed on the print substrate 40 in one roll-to-roll process.

In a conventional process using a gravure or offset pattern, there was a chronic problem of a slippage between a pattern mask and a substrate to impair the precision of printing. In the present invention, however, by forming a pattern mask on a surface of a roll and configuring the roll and ink injector such that there is no relative movement between the pattern mask and the substrate at the moment the ink is injected, it is ensured that there is no slip region between the roll and the print substrate. By executing injection of ink and printing with no relative speed between the pattern mask and the substrate, the present invention ensures such a high printing precision for a high-speed roll-to-roll printing as can be obtainable only under a static printing condition, and at the same time, enhances productivity and greatly saves production cost and time.

While particular forms of the inventions have been illustrated and described, it will be apparent to those skilled in the art that various modifications, additions and substitutions can be made without departing from the inventive concept. References to use of the invention with a specific materials, parts, or procedures in describing and illustrating the invention herein are by way of example only, and the described embodiments are to be considered in all respects only as illustrative and not restrictive. The present invention may be embodied in other specific forms without departing from its spirit or essential characteristics. Accordingly, it should be understood that the scope of the invention is defined by the accompanying claims only.

We claim:

1. A method of roll-to-roll printing, the method comprising:
moving a print substrate in a direction;
disposing a pattern mask over the print substrate, the pattern mask having a perforated pattern and being wound on a roll such that a side of the pattern mask faces the print substrate; and
injecting ink onto the print substrate through the perforated pattern; and
maintaining a speed difference between the pattern mask and the print substrate substantially at zero at the moment the ink is injected.

2. The method of claim 1, further comprising:
rotating an ink injector; and
rotating the roll.

3. The method of claim 2, wherein the ink injector and the roll are rotated in mutually different directions.

4. The method of claim 2, wherein maintaining a speed difference between the pattern mask and the print substrate substantially at zero includes controlling respective rotation speeds of the ink injector and the roll.

5. The method of claim 2, wherein the ink injector is mounted on the roll.

6. The method of claim 5, wherein the ink injector is mounted along an axis of the roll, the axis being perpendicular to the moving direction of the printing substrate.

7. The method of claim 6, wherein the ink injector is capable of moving in the axial direction of the roll.

8. The method of claim 2, further comprising moving the roll in the same direction as the moving direction of the printing substrate.

9. The method of claim 2, further comprising:
detecting a position of a pattern previously printed on the print substrate; and
controlling a relative position between the print substrate and the pattern mask using the detected position.

10. The method of claim 9, wherein controlling a relative position includes controlling relative rotations of the ink injector and the roll, depending on the detected position.

11. A method of roll-to-roll printing, the method comprising:
moving a print substrate in one direction;
moving a pattern mask in the same direction as the moving direction of the printing substrate, the pattern mask having a perforated pattern to be printed on the print substrate, and being wound in a loop fashion around at least two rolls spaced apart from each other such that a side of the pattern mask faces the print substrate; and
injecting ink from an ink injector onto the print substrate through the perforated pattern; and
maintaining a speed difference between the pattern mask and the print substrate substantially at zero at the moment the ink is being injected.

12. The method of claim 11, further comprising:
detecting a position of a pattern previously printed on the print substrate; and
aligning the print substrate with the pattern mask using the detected position.

13. The method of claim 12, wherein aligning the print substrate with the pattern mask includes moving the pattern mask in a direction parallel or perpendicular to the moving direction of the printing substrate, depending on the detected position, using a drive structure that transfers the pattern mask.

14. The method of claim 13, wherein aligning the print substrate and the pattern mask further includes rotating the pattern mask, depending on the detected position, using the drive structure.

15. An apparatus for roll-to-roll printing, comprising:
a print substrate moving in a direction;
a roll disposed over the print substrate;
a pattern mask wound on the roll such that a side of the pattern mask faces the print substrate, the pattern mask having a perforated pattern to be printed on the print substrate; and
an ink injector disposed over the print substrate and configured to inject ink onto the print substrate through the perforated pattern of the pattern mask, wherein the roll and the ink injector are configured such that a speed difference between the pattern mask and the print substrate at the moment that the ink is injected is maintained substantially at zero.

16. The apparatus of claim 15, further comprising:
a first drive unit for rotating the ink injector;
a second drive unit for rotating the roll;
at least one position sensor for detecting a position of a pattern previously printed on the print substrate; and
a control unit for controlling the first and second drive units to adjust a relative position between the print substrate and the pattern mask, depending on the position detected by the at least one position sensor.

17. The apparatus of claim 16, wherein the first and second drive units are configured to rotate the ink injector and the roll in different directions.

18. The apparatus of claim 16, wherein the ink injector is mounted on the roll.

19. The apparatus of claim 18, wherein the ink injector is mounted along an axis of the roll, the axis being perpendicular to the moving direction of the printing substrate.

20. The apparatus of claim 19, wherein the ink injector is configured to be capable of moving in the axial direction of the roll.

21. The method of claim 19, wherein the roll is configured to move in the same direction as the moving direction of the printing substrate.

22. An apparatus for roll-to-roll printing, comprising
a print substrate moving in a direction;
at least two spaced-apart rotating rolls;
a pattern mask wound around the at least two rolls in a loop fashion such that a side of the pattern mask faces the print substrate, the pattern mask having a perforated pattern to be printed on the print substrate; and
an ink injector disposed over the print substrate to inject ink onto the print substrate through the perforated pattern of the pattern mask, wherein the at least two rolls and the ink injector are configured such that a speed difference between the pattern mask and the print substrate is maintained substantially at zero at the moment the ink injector injects ink.

23. The apparatus of claim 21, further comprising:
at least one position sensor for detecting a position of a pattern previously printed on the print substrate; and
a drive structure in mechanical communication with the at least two rolls for transferring the pattern mask, wherein the drive structure is configured to move the pattern mask in a direction parallel or perpendicular to the moving direction of the printing substrate, or rotate the pattern mask, depending on the detected position, for aligning the print substrate with the pattern mask.
